(19) United States
(12) Patent Application Publication
(10) Pub. No.: US 2025/0369561 A1
(43) Pub. Date: Dec. 4, 2025

(54) SOLID SIDING MOUNTING BLOCK

(71) Applicant: Pontiac Trail Products, LLC, Novi, MI (US)

(72) Inventors: Michael W. Maurer, Novi, MI (US); Christopher David Meeks, Greensboro, NC (US)

(73) Assignee: Pontiac Trail Products, LLC, Novi, MI (US)

(21) Appl. No.: 19/299,988

(22) Filed: Aug. 14, 2025

Related U.S. Application Data
(62) Division of application No. 18/463,362, filed on Sep. 8, 2023.
(60) Provisional application No. 63/404,607, filed on Sep. 8, 2022.

(51) Int. Cl. F16M 13/02; H02G 3/12

(52) U.S. Cl. CPC F16M 13/02; H02G 3/12

(57) ABSTRACT

A solid siding mounting block, including a backplate configured to be mounted in either vertical application horizontally. The backplate has a nail flange, a perimeter wall extending substantially perpendicular to the nail flange, and one or more attachment bosses. A face block is formed from solid siding and configured to be attached to the backplate and is characterized by an absence of a snap ring. The backplate may be formed as a single piece or as a two-piece member, having a first piece and a second piece. One of the first or second piece has a tooth and the other of the first or second piece has a receiver. A two-piece electrical box having a first piece with one or more first holes and one or more receiver grooves. A second piece has second holes, which may be aligned with the first holes.

### CLAIM OF PRIORITY AND CROSS-REFERENCE TO RELATED APPLICATIONS

This application is a divisional of U.S. patent application Ser. No. 18/463,362, which was filed on Sep. 8, 2023, is now pending, and claims the benefit of and priority to U.S. Provisional Application No. 63/404,607, which was filed on Sep. 8, 2022, and is now expired. Both of the foregoing patent applications are incorporated herein by reference in their respective entireties and for all purposes.

### INTRODUCTION

This disclosure generally relates to mounting blocks for solid siding. Different types of solid siding include, without limitation, composite, mineral composite, fiber cement siding or cement board siding, or cellular PVC, any of which may include insulating materials. These types of siding are, generally, durable siding options that are available in a variety of styles, colors, and designs.

### SUMMARY

A solid siding mounting block, including a backplate configured to be mounted in either vertical application horizontally. The backplate has a nail flange, a perimeter wall extending substantially perpendicular to the nail flange, and one or more attachment bosses. A face block is formed from solid siding and configured to be attached to the backplate, such that the face block is attached to the one or more attachment bosses and the backplate is characterized by an absence of a snap ring.

The solid siding mounting block may include one or more water drainage spacers that protect against water intrusion regardless of installation orientation and create a drainage gap between the face block and the perimeter wall. The solid siding mounting block may include a perimeter raised section between the nail flange and the perimeter wall, wherein the perimeter raised section is configured to receive caulking. The backplate may be formed as a single piece or a two-piece member, having a first piece and a second piece.

The solid siding mounting block may also have a two-piece electrical box having a first piece with one or more first holes and one or more receiver grooves, and a second piece, including one or more second holes. The second holes may generally be aligned with the first holes of the first piece. The two-piece electrical box may have a third piece having protrusions configured to interface with the one or more of the receiver grooves.

The above features and advantages, and other features and advantages, of the present disclosure are readily apparent from the following detailed description of some of the best modes and other embodiments for carrying out the disclosure, which is defined solely by the appended claims, when taken in connection with the accompanying drawings.

### BRIEF DESCRIPTION OF THE DRAWINGS

FIG. 1 is a schematic front view of a hoodless back plate.

FIG. 2 is a schematic side view of a hoodless back plate.

FIG. 3 is a schematic front/top isometric view of a hoodless back plate.

FIG. 4 is a schematic back/top isometric view of a hoodless back plate.

FIG. 5 is a schematic front view of a hoodless back plate.

FIG. 6 is a schematic plane intersection view of a hoodless back plate.

FIG. 7 is a schematic cross-sectional view of a hoodless back plate.

FIG. 8 is a schematic back view of a hoodless back plate.

FIG. 9 is a schematic plane intersection view of a hoodless back plate.

FIG. 10 is a schematic cross-sectional view of a hoodless back plate.

FIG. 11 is a schematic front view of a hoodless block assembly.

FIG. 12 is a schematic plane intersection view of a hoodless block assembly, showing a face block.

FIG. 13 is a schematic cross-sectional view of a hoodless block assembly, showing a face block.

FIG. 14 is a schematic front/top isometric view of a hoodless block assembly.

FIG. 15 is a schematic back/top isometric view of a hoodless block assembly.

FIG. 16 is a schematic front view of a hoodless block assembly.

FIG. 17 is a schematic side view of a hoodless block assembly.

FIG. 18 is a schematic front view of a single-piece hoodless block.

FIG. 19 is a schematic plane intersection view of a single-piece hoodless block.

FIG. 20 is a schematic cross-sectional view of a single-piece hoodless block.

FIG. 21 is a schematic front view of a recessed single-piece hoodless block.

FIG. 22 is a schematic side view of a recessed single-piece hoodless block.

FIG. 23 is a schematic front/top isometric view of a recessed single-piece hoodless block.

FIG. 24 is a schematic back/top isometric view of a recessed single-piece hoodless block.

FIG. 25 is a schematic front view of a recessed single-piece hoodless block.

FIG. 26 is a schematic cross-sectional view of a recessed single-piece hoodless block.

FIG. 27 is a schematic plane intersection view of a recessed single-piece hoodless block.

FIG. 28 is a schematic front view of a split block assembly.

FIG. 29 is a schematic side view of a split block assembly.

FIG. 30 is a schematic front/bottom isometric view of a split block assembly.

FIG. 31 is a schematic back view of a split block assembly.

FIG. 32 is a schematic back/bottom isometric view of a split block assembly.

FIG. 33 is a schematic back view of a split block assembly.

FIG. 34 is a schematic cross-sectional view of a split block assembly.

FIG. 35 is a schematic enlarged cross-sectional view of a split block assembly.

FIG. 36 is a schematic exploded front view of a split block assembly.

FIG. 37 is a schematic exploded front/bottom isometric view of a split block assembly.

FIG. 38 is a schematic exploded back/bottom isometric view of a split block assembly.

FIG. 39 is a schematic back/top isometric view of a hoodless back plate for an electrical box.

FIG. 40 is a schematic front/top isometric view of a hoodless back plate for an electrical box.

FIG. 41 is a schematic front view of a hoodless back plate for an electrical box.

FIG. 42 is a schematic side view of a hoodless back plate for an electrical box.

FIG. 43 is a schematic front view of a hoodless back plate for an electrical box.

FIG. 44 is a schematic plane intersection view of a hoodless back plate for an electrical box.

FIG. 45 is a schematic cross-sectional view of a hoodless back plate for an electrical box.

FIG. 46 is a schematic front view of a hoodless block assembly for an electrical box.

FIG. 47 is a schematic plane intersection view a hoodless block assembly for an electrical box.

FIG. 48 is a schematic cross-sectional view of a hoodless block assembly for an electrical box.

FIG. 49 is a schematic front view of a single-piece, hoodless block for an electrical box.

FIG. 50 is a schematic side view of a single-piece, hoodless block for an electrical box.

FIG. 51 is a schematic front/top isometric view of a single-piece, hoodless block for an electrical box.

FIG. 52 is a schematic back/top isometric view of a single-piece, hoodless block for an electrical box.

FIG. 53 is a schematic front view of a single-piece, hoodless block for an electrical box.

FIG. 54 is a schematic cross-sectional view of a single-piece, hoodless block for an electrical box.

FIG. 55 is a schematic plane intersection view of a single-piece, hoodless block for an electrical box.

FIG. 56 is a schematic front view of a single-piece, hoodless block assembly for an electrical box.

FIG. 57 is a schematic cross-sectional view of a single-piece, hoodless block assembly for an electrical box.

FIG. 58 is a schematic plane intersection view of a single-piece, hoodless block assembly for an electrical box.

FIG. 59 is a schematic top half of a split block, showing drainage holes/channels.

FIG. 60 is a schematic back view of a single-piece hoodless block, showing drainage holes/channels.

FIG. 61 is a schematic, zoomed, plane intersection view of a single-piece hoodless block, showing drainage holes/channels.

FIG. 62 is a schematic exploded isometric front/top view of an electrical box assembly.

FIG. 63 is a schematic exploded side view of an electrical box assembly.

FIG. 64 is a schematic back view of a single-piece, hoodless block assembly for an electrical box.

FIG. 65 is a schematic plane intersection view of a single-piece, hoodless block assembly for an electrical box.

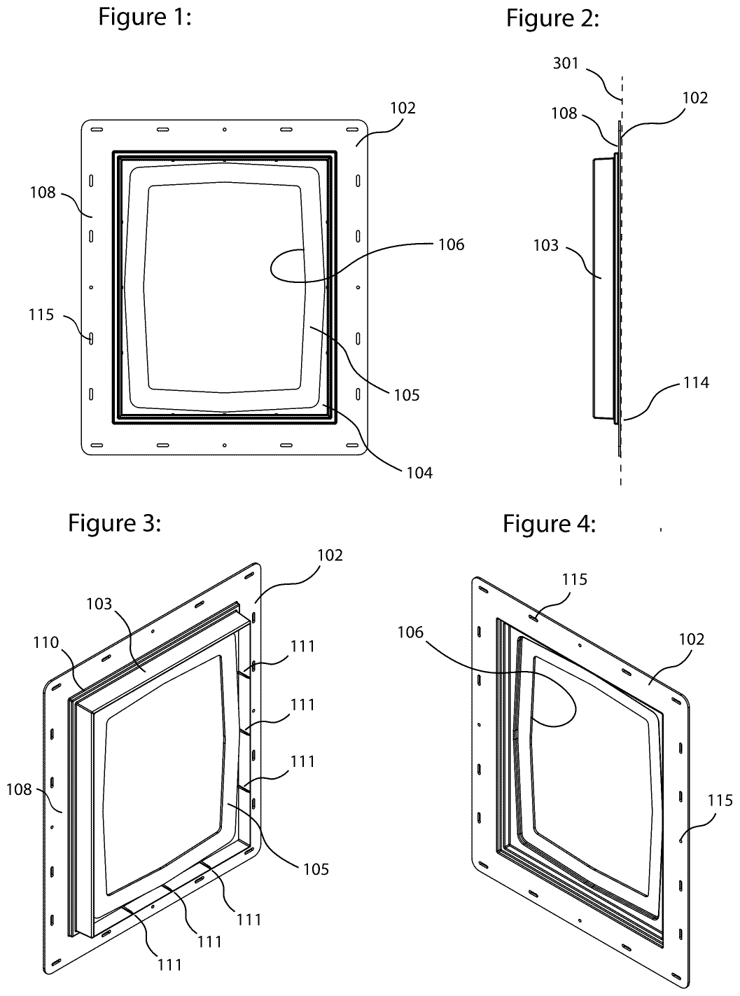

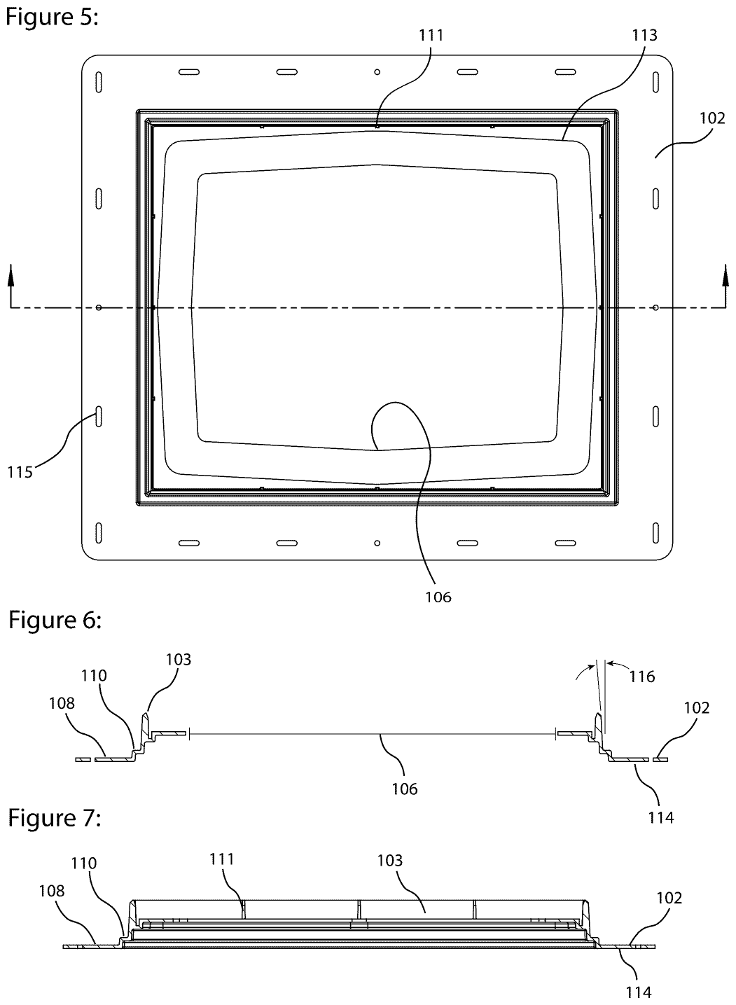

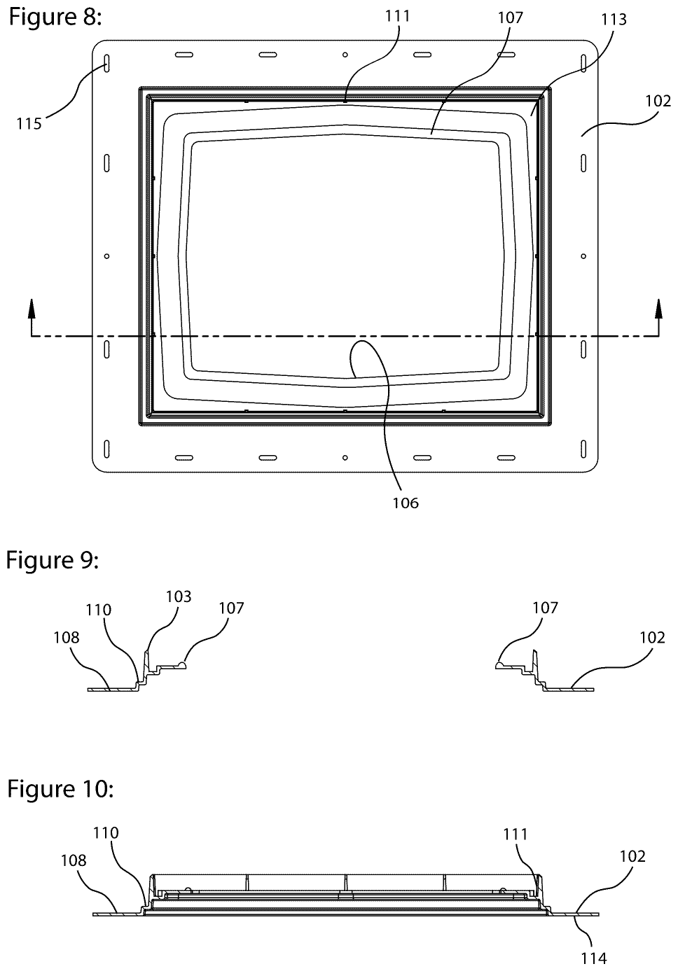

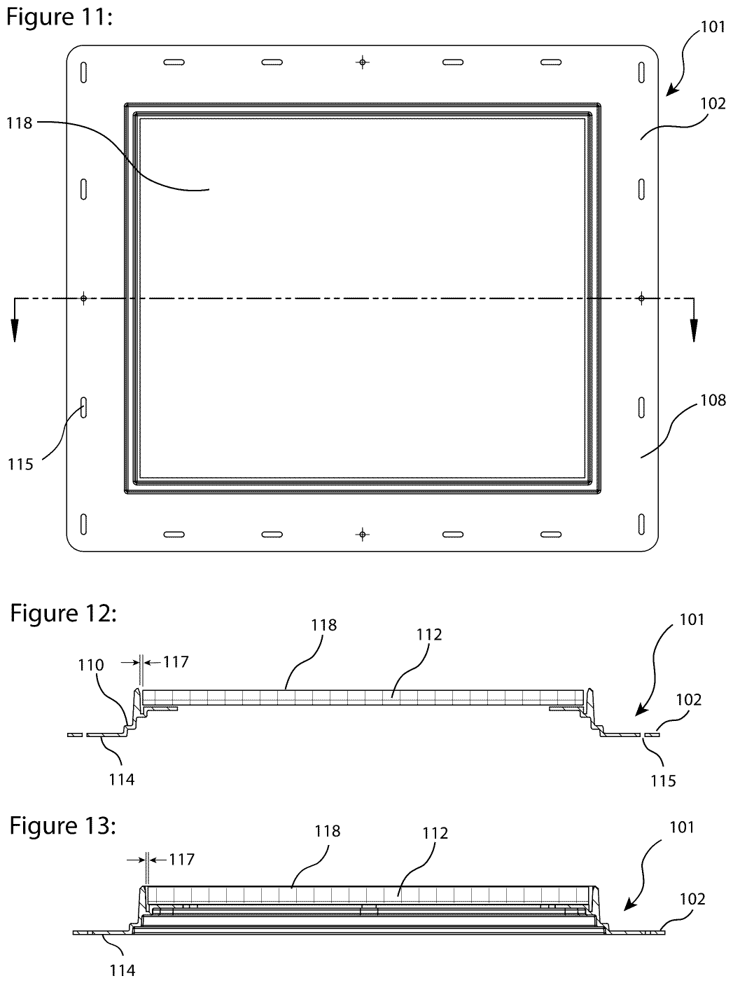

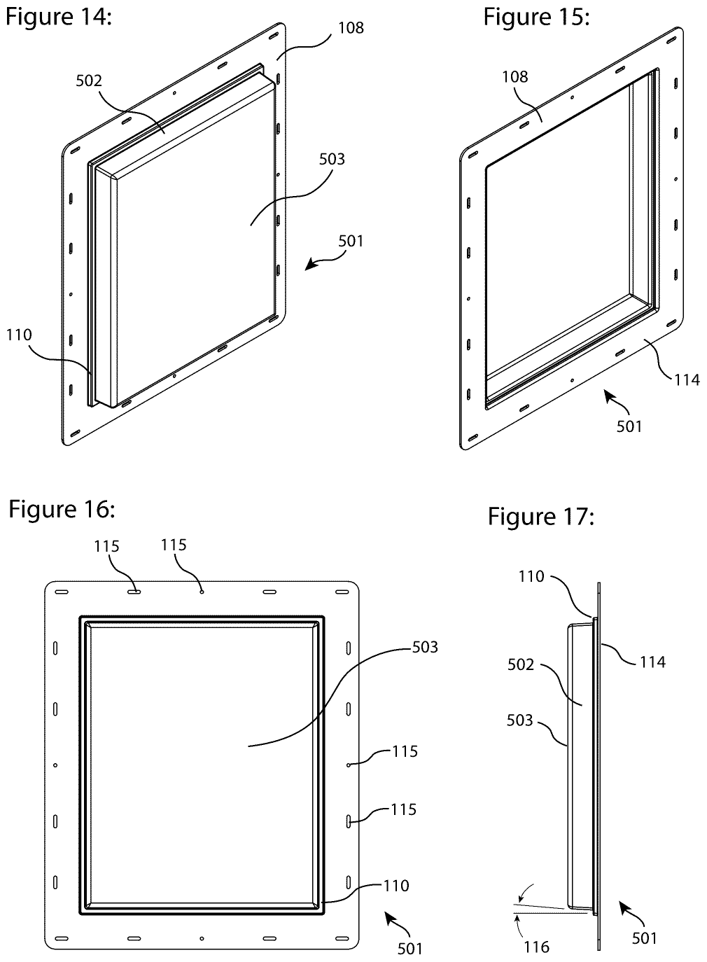

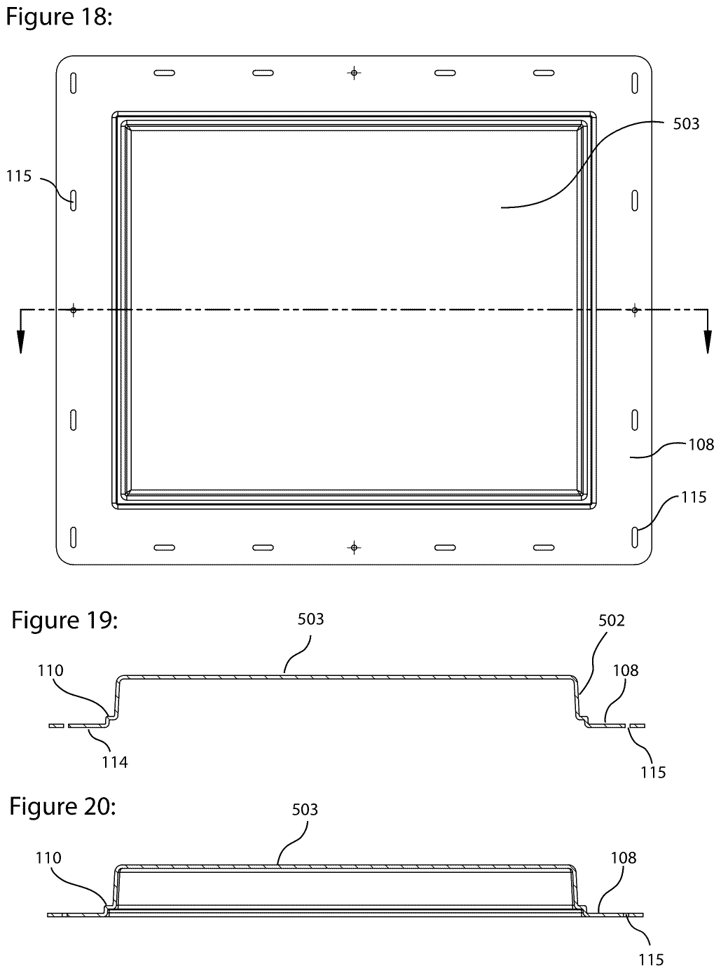

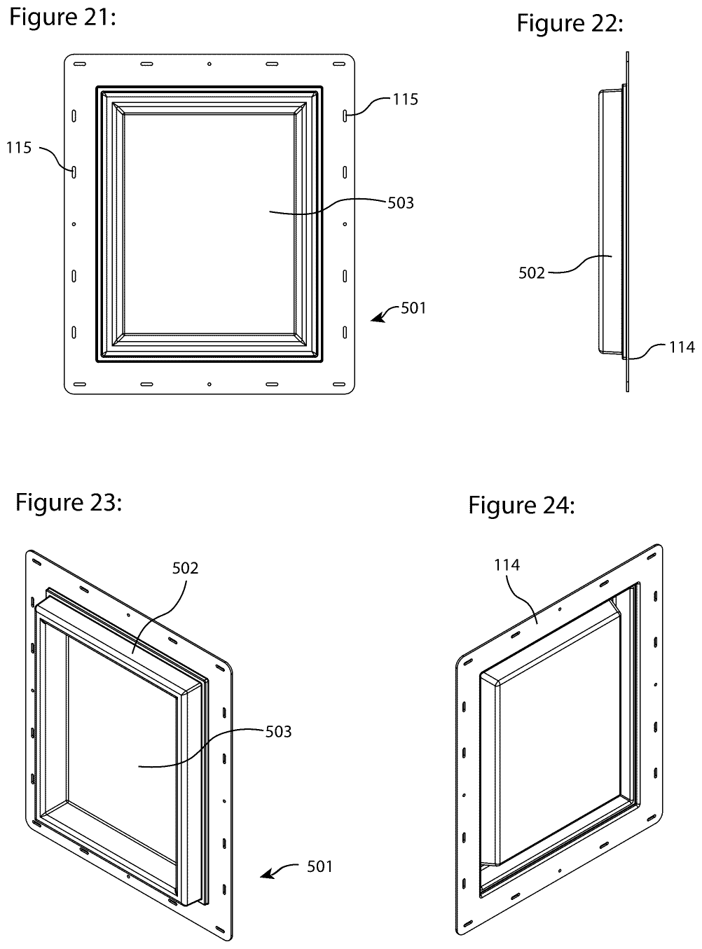

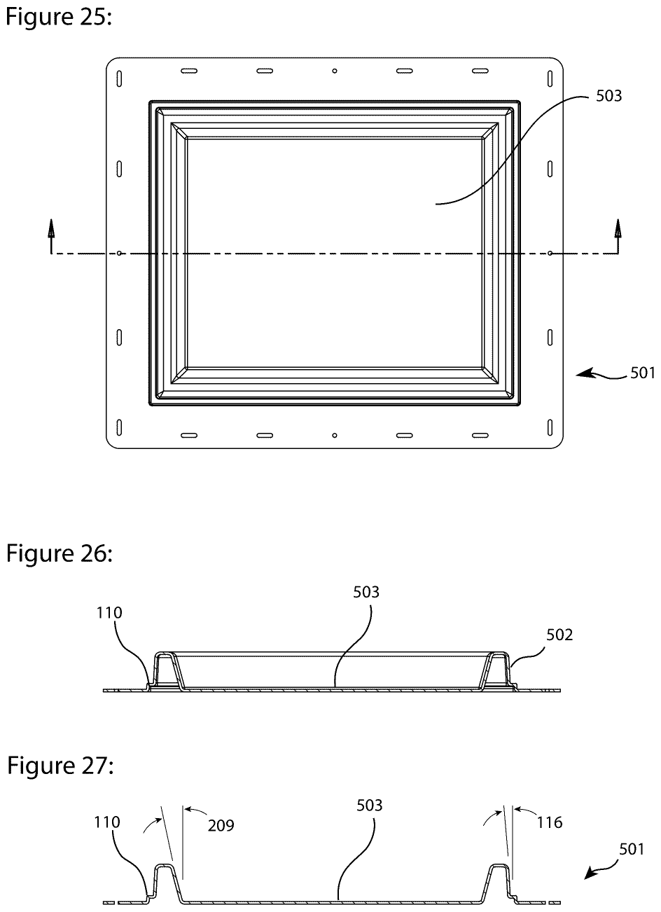

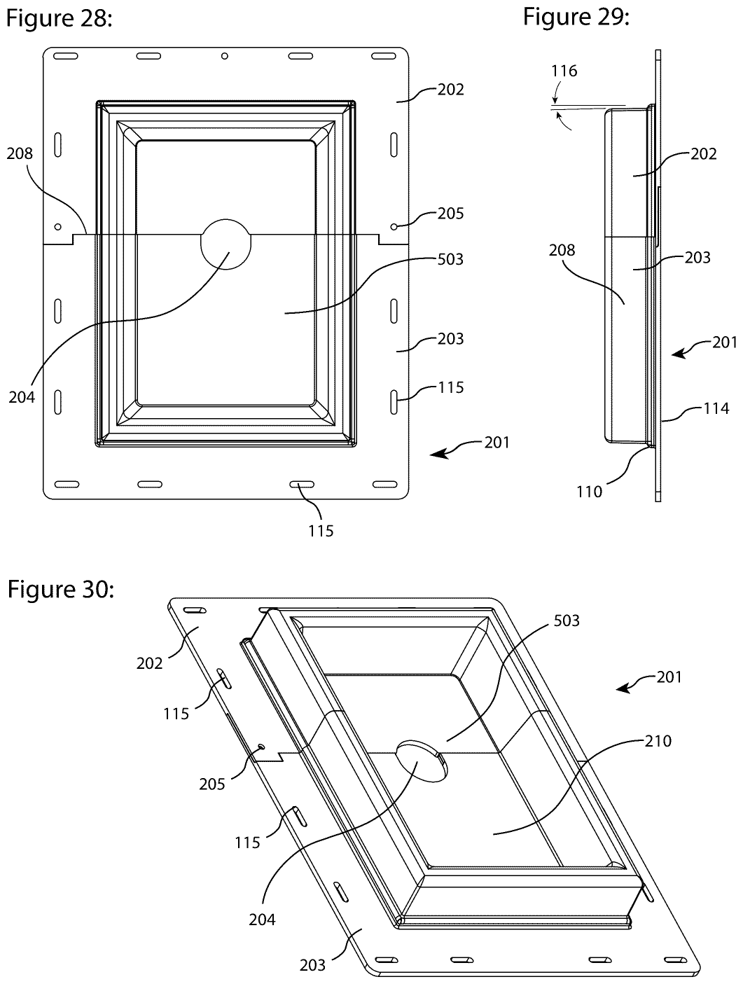

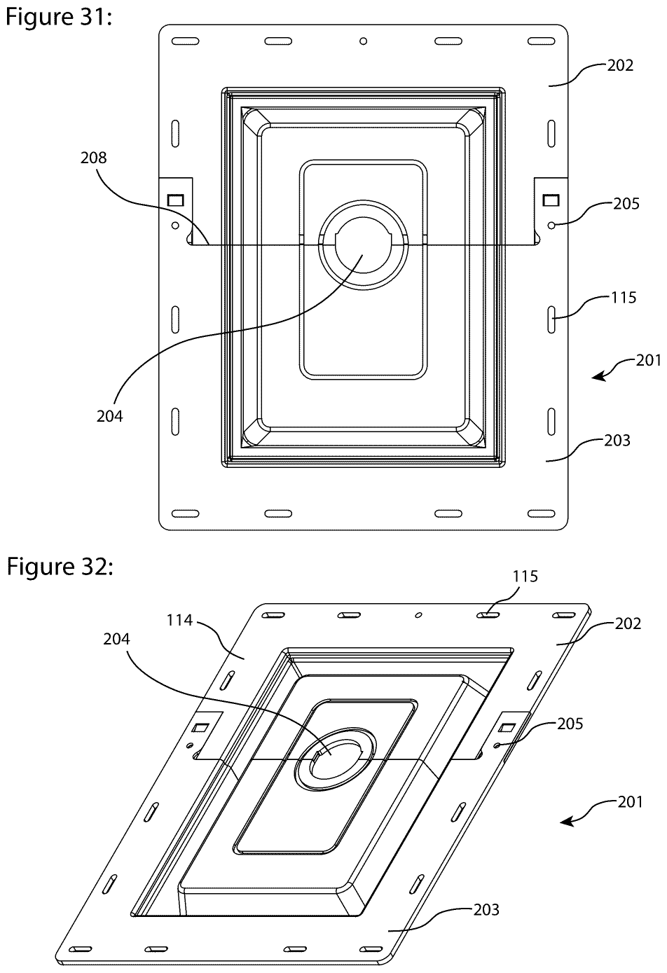

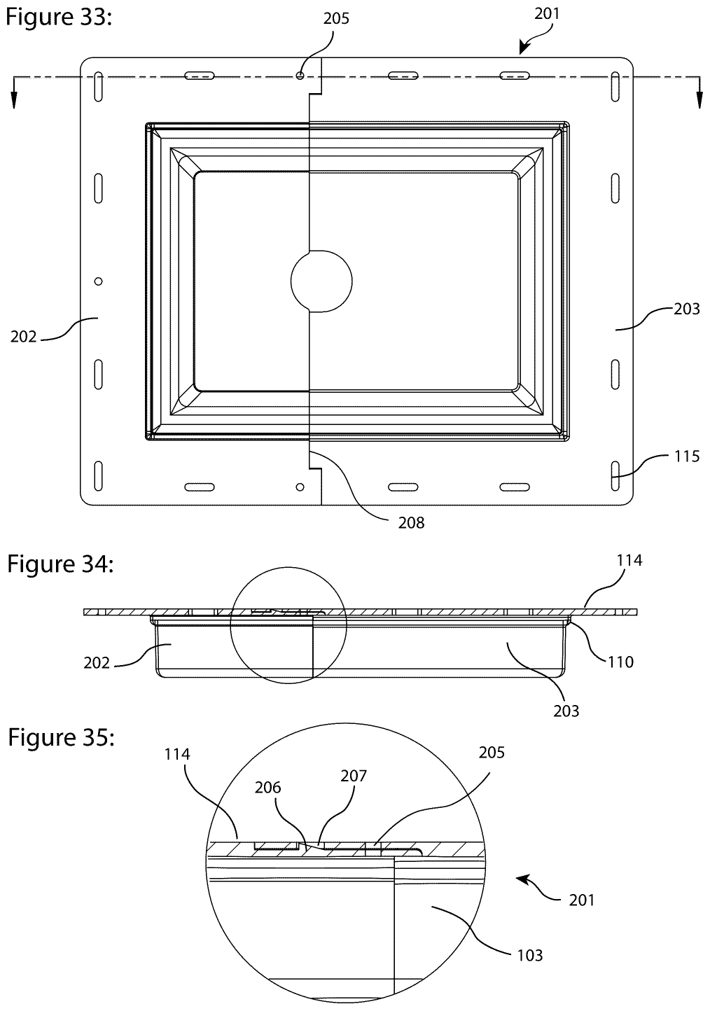

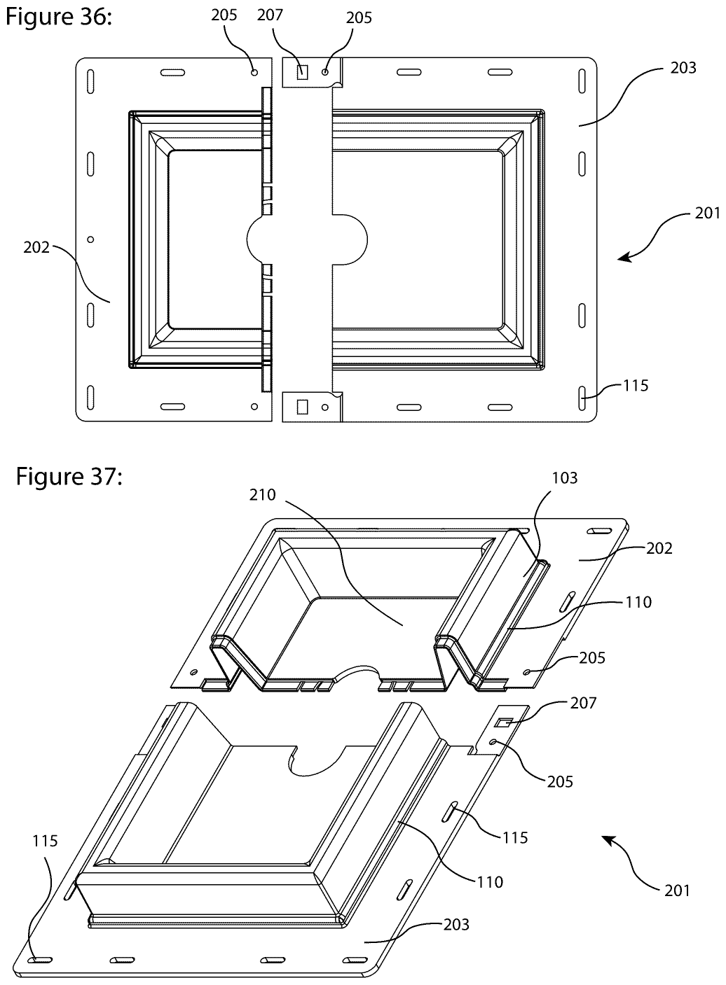

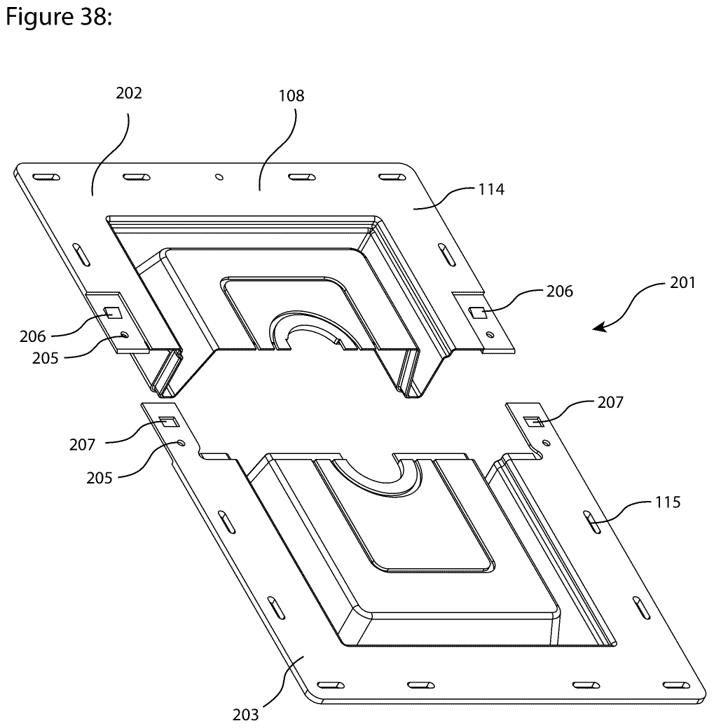

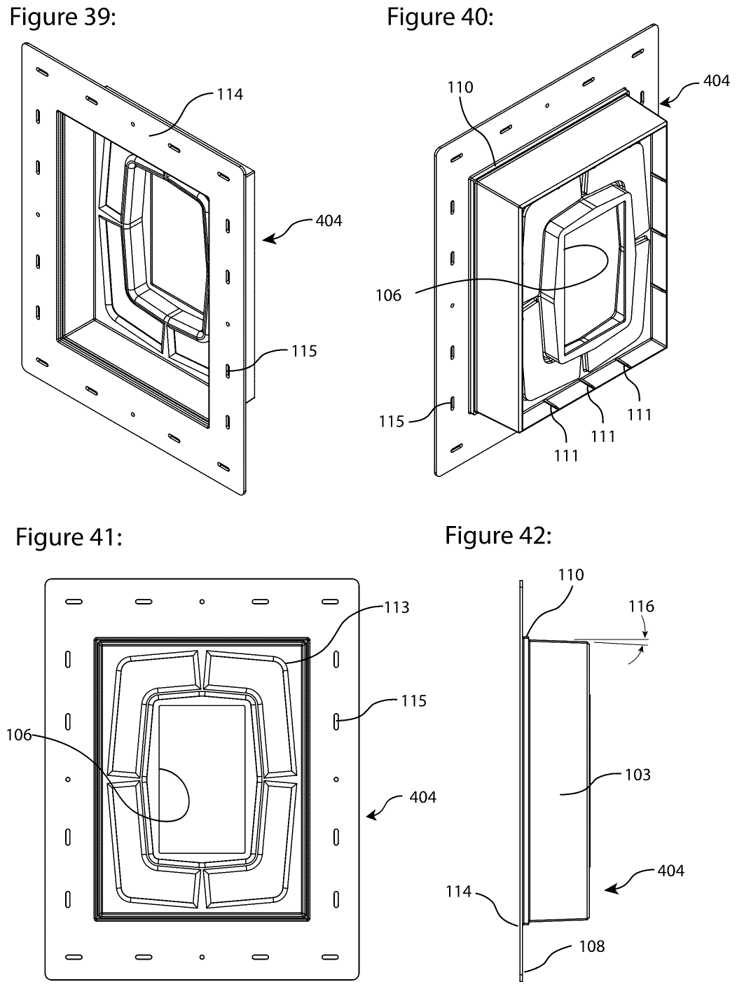

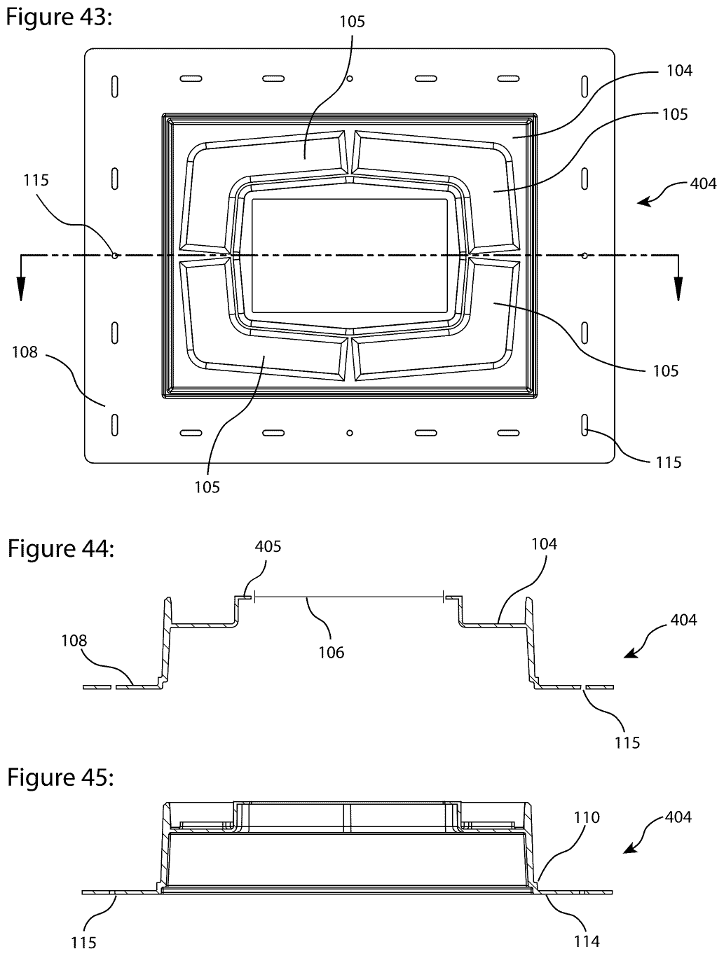

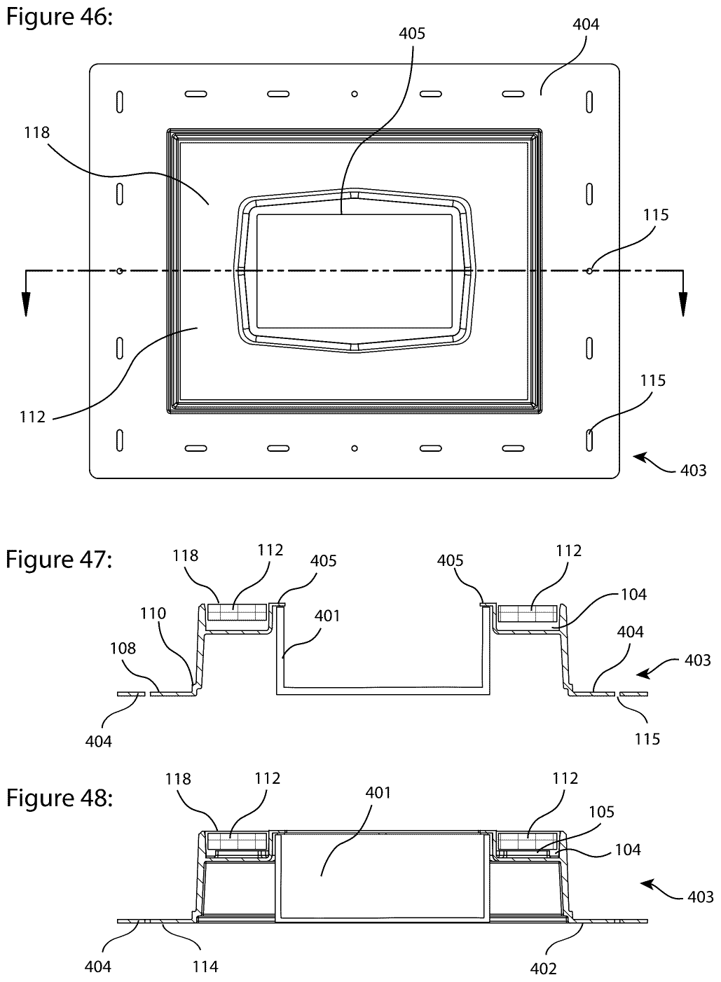

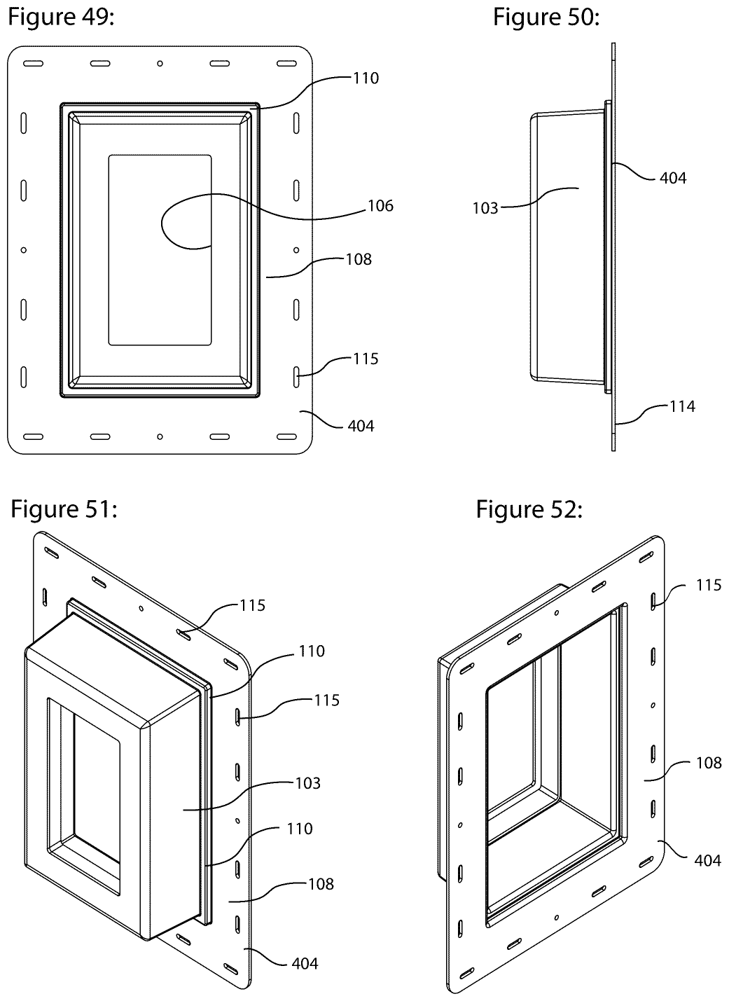

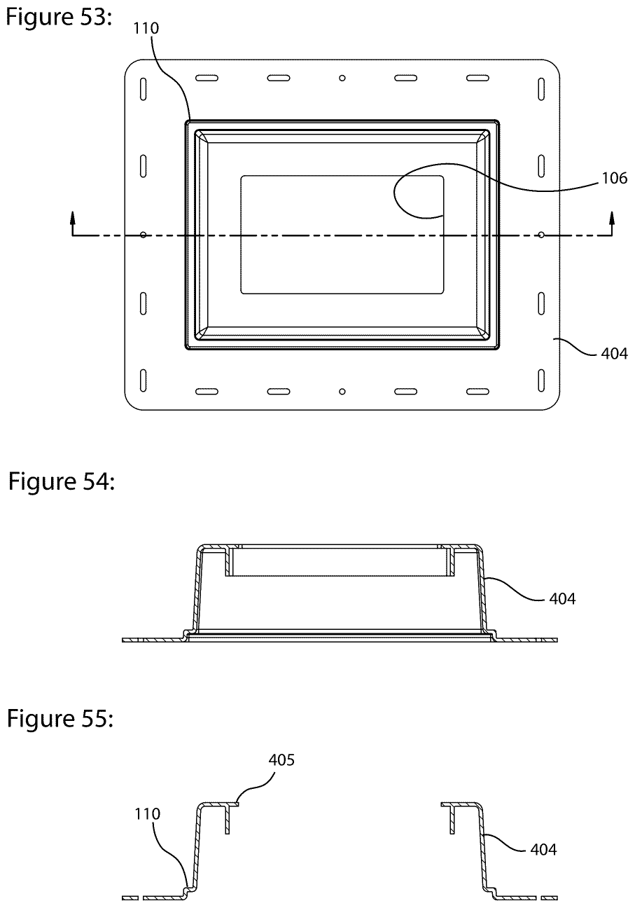

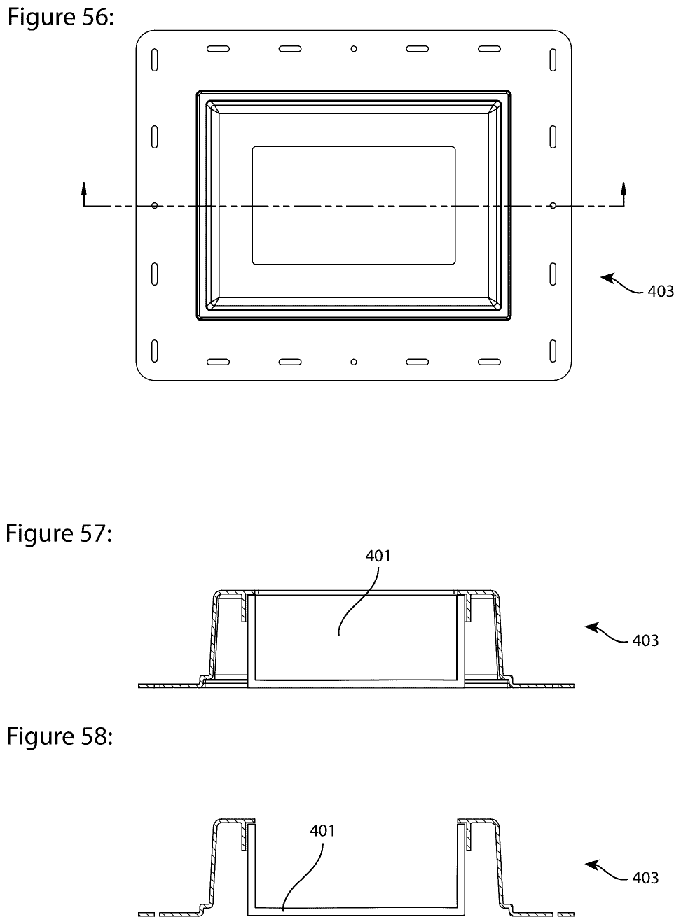

### DETAILED DESCRIPTION

Referring to the drawings, like reference numbers correspond to like or similar components wherever possible throughout the several figures. All figures may be referred to in any section of the specification without regard to numerical order.

A single-piece, hoodless block 501, or simply hoodless block 501, offers a simple design and a low-cost option in any market. This may also be referred to as a solid siding mounting block. Attached perimeter walls 502 connect to a molded mounting surface 503, which may be molded directly with the single-piece hoodless block 501. Note that the hoodless block 501 may have several, different configurations, including, without limitation, a hoodless block assembly 101 and a split block assembly 201.

While the present disclosure may be illustrated with respect to particular industries or applications, those skilled in the art will recognize the broader applicability of the products, methods, and techniques, described herein. For example, similar structures, methods, or combinations thereof, may be used in other industries or for medical procedures other than those described herein.

Those having ordinary skill in the art will also recognize that terms such as “above,” “below,” “upward,” “downward,” et cetera, are used descriptively of the figures, and do not represent limitations on the scope of the appended claims. Any numerical designations, such as “first” or “second” are illustrative only and are not intended to limit the scope of the claims in any way.

When used herein, the term “substantially” refers to relationships that are ideally perfect or complete, but where manufacturing realties prevent absolute perfection. Therefore, substantially denotes typical variance from perfection in the relevant art. For example, if height A is substantially equal to height B, it may be preferred that the two heights are 100.0% equivalent, but manufacturing realities likely result in the distances varying from such perfection. Skilled artisans would recognize the amount of acceptable variance. For example, and without limitation, coverages, areas, or distances may generally be within 10% of perfection for substantial equivalence. Similarly, relative alignments, such as parallel or perpendicular, may generally be within 5%.

Features shown in one figure may be combined with, substituted for, or modified by, features shown in any of the figures. Unless stated otherwise, no features, elements, or limitations are mutually exclusive of any other features, elements, or limitations. Any specific configurations shown in the figures are illustrative only and the specific configurations shown are not limiting. Any use of the term, “or,” whether in the description or claims, is inclusive of any specific element referenced and, also, includes any combination of the elements referenced, unless otherwise explicitly stated.

A hoodless backplate 102 may be, without limitation, a one-piece, injection-molded plastic part. On the hoodless backplate 102, a perimeter wall 103 exists to house the sides of a face block 112, which has a face block surface 118. Around the perimeter wall 103 is a nail flange 108 and a perimeter raised section 110. The nail flange 108 may be generally perpendicular to the perimeter wall 103.

The back side of the nail flange 108 is defined as a wall mating surface 114, which is generally attached to a wall 301. The hoodless backplate 102 has a wall and a show surface but has no top or bottom and may be mounted vertically or horizontally.

The nail flange 108 is a flange with multiple nail slots 115 designed to hold the hoodless block assembly 101 to the wall 301. Nail slots are typically ⅜″ to 1.5″ in length and approximately ⅛″ wide, without limitation. The nail flange 108 is typically designed to be 0.75″ to 1.5″ in length depending on the application. Note that all dimensions provided herein are exemplary and do not limit the scope of the invention. All dimensions given herein are exemplary and non-limiting of the scope of the description.

Attached to the nail flange 108 and the perimeter wall 103 is the perimeter raised section 110. This feature is designed to fill volume where caulking—not shown in the figures—is used. This allows the installer to use less caulk, saving both time and money.

The perimeter raised section 110 guarantees standard spacing between perimeter wall 103 and siding—not shown in the figures, although the face block 112 may be formed from the same type of solid siding. This may generally prevent installation issues, including, without limitation, a thin caulk line that cracks during expansion and contraction due to temperature fluctuation or an overly thick caulk line that increases assembly cost and time.

The perimeter wall 103 is designed to have sufficient draft 116 to allow water to use gravity to drain. As used herein, water refers to any type of moisture that would, preferably, be prevented from moving behind any of the blocks described herein. The draft angle for water drainage is typically, without limitation, 1.5 degrees or greater.

An inner wall draft 209 was considered was created to improve the draft angle of this wall, and is considerably larger than most applications, in this instance, without limitation, it is a 15-degree draft angle. However, other draft angles may be used, including, without limitation, great than 8 or 12 degrees. Other walls have 1.5-3 degrees of draft. The increased draft on this wall generally allows for both an easier painting surface and faster water runoff.

The leading edge, or drip edge, of the perimeter wall 103 has a chamfer with an angle greater than the main perimeter wall 103 to promote water acceleration that leads to faster dripping and prevents water or moisture from draining behind the face block 112. This is a substantial design improvement, which substantially minimizes water intrusion, installation time, cost, and design simplicity, among other factors recognizable to those having ordinary skill in the art.

Standard Block with Face Block Surface.

This is similar to the single-piece, hoodless block 501 but includes the face block 112, instead of the molded mounting surface 503. The hoodless backplate 102 combined with the face block 112 creates the hoodless block assembly 101. In many cases, this is believed to be a more premium option as the show surface matches the siding surface, because the face block 112 is formed from the same material as the siding or cladding.

The hoodless block assembly 101 will consist of the hoodless backplate 102 attached to the face block 112 via mechanical attachments, including, without limitation: screws, nails, staples; and/or adhesives, including, without limitation: glue, sealant, epoxy.

The perimeter wall 103 is designed to be forward of the face block 112. When water is on a horizontal section of the perimeter wall 103, it will tend to drip onto the outer section of the face block 112, instead of traveling behind the face block 112.

A typical, alternative, mounting block for this application would have a block with a hood or flashing detail protecting the top. However, the hoodless backplate 102, or hoodless block backplate, eliminates the need for a hood or flashing by including a recessed water diverter 104 inside the perimeter wall 103 of the hoodless backplate 102 designs.

When water travels behind the face block 112, sufficient countermeasures have been implemented to redirect the water, or other moisture, forward. First, the water will enter the recessed water diverter 104, which is a pathway created to allow for water to have a direct drainage path away from the wall 301. In many applications there will be a penetration coming from the wall 301. This design has the penetration—which may be, for example and without limitation, wires, a light fixture, or hose spigot—come through a hole in the center of the block, referred to as a protrusion cutout 106.

The recessed water diverter 104 typically includes a channel allowing for drainage around the perimeter of the face block 112. This may allow for the hoodless block assembly 101 to be installed with any of the 4 sides facing upwards and without the need of a hood, as the recessed water diverter 104 will drain in any direction or orientation.

Inside the perimeter wall 103 one or more attachment bosses 105 exists. The attachment bosses 105 are where fasteners-mechanical and/or adhesive, as described above-will be installed connecting the hoodless backplate 102 to the face block 112. The surface created by the attachment bosses 105 and the recessed water diverter 104 creates a surface called a deck 113. Some designs only require one attachment boss 105 but other designs may utilize multiple attachment bosses 105 allowing for more recessed water diverters 104. In some configurations, the face block 112 may be attached directly to the recessed water diverter 104.

When the attachment means is sufficiently tight between the attachment bosses 105 and face block 112, water tension prevents water from moving between the attachment bosses 105 and the face block 112 and forces water to drain around the recessed water diverter 104 feature, including the perimeter channel. The attachment bosses 105 are touching the face block 112 allowing for glue, staples, or other attachment mechanisms. The recessed water diverter 104 creates a gap through which water may drain between the face block 112 and the perimeter wall 103.

Around the protrusion cutout 106, a final water defense may exist, which may be referred to as a sealing lip 107. This is a small, generally sharp feature designed to press into, or deform against, the face block 112, once the face block 112 is attached. The sealing lip 107 then creates a tight seal between the face block 112 and the hoodless backplate 102.

One or more water drainage spacers 111 may be formed on the hoodless backplate 102. These are, generally, small ribs designed to maintain a drainage gap 117 between the perimeter wall 103 and the face block 112. When water gets behind the face block 112 it will travel through the recessed water diverter 104 and out the drainage gap 117.

### Electrical Box.

In some instances, it may be necessary to include a box to hold electrical wiring that meets specific requirements, including UL certifications, which may be referred to as an electrical box 401 or electrical box assembly 401. The hoodless block assembly 101 or the single-piece, hoodless block 501 may accommodate this.

The electrical box 401 was designed to fit in the space between a wall mating surface plane 402 and the backside of the deck 113. Substantially all of the box volume is outside of the wall 301 for case of installation. It is important to note that the electrical box 401 can also be recessed into the wall 301, but that may be less convenient for installation. An electrical box block assembly 403, includes an electrical box front 404 and an electrical box cover 405.

The electrical box 401 easily adapts to the single-piece hoodless block 501. It has, at least, three atypical features. First is a raised lip 406, which extends out past the molded mounting surface 503 or the face block 112 depending on the application. Next are side attachment snaps 407 and side receivers 410.

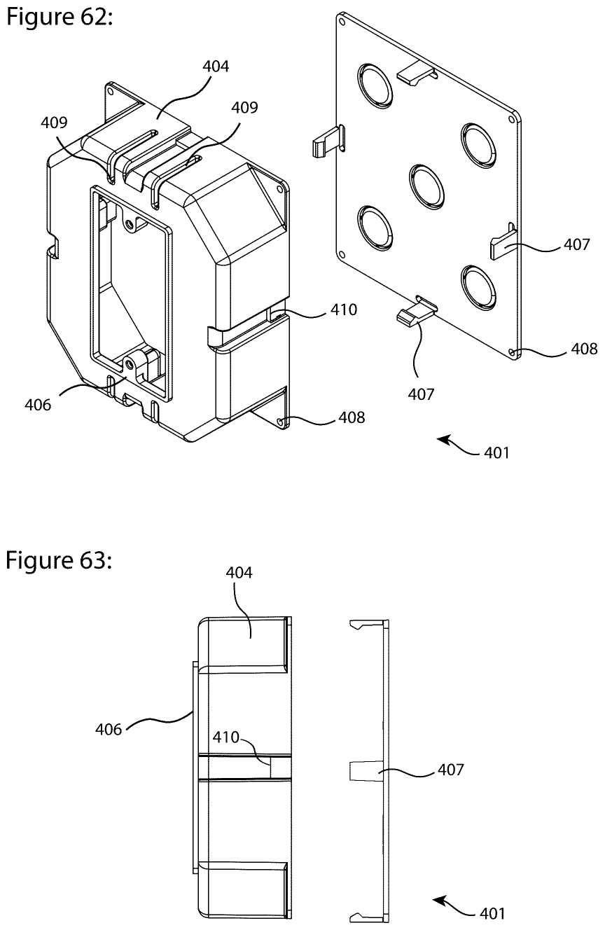

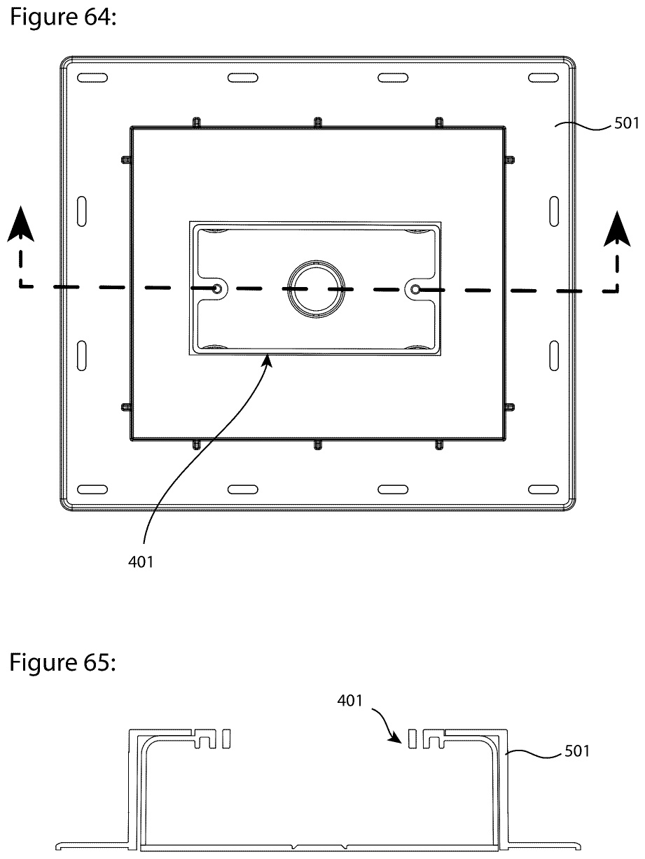

A front half, which may be the electrical box front 404, and back half, not numbered but shown in FIGS. 62 and 63, may be required based on the design, which may be made by, without limitation, injection molding. The side attachment snaps 407 and the side receivers 410 may be used to attach the two features, which are located on the sides to keep them away from the corners, where fasteners are typically placed to attach the electrical box 401 to the wall 301.

In the event of an installation error, the installer could damage the snaps 407 if they were located close to the snaps 407. Generally, the top and bottom pieces use the same wall attachment holes 408. This means that the fasteners are holding both the front and back half to the wall. Competitor designs generally rely on the snaps to hold the electrical box 401 to the wall.

The electrical box front 404 may include one or more grooves 409 formed therein. These may be mated to similar, but extending inward, structures on the electrical box cover 405—these may be similar to the inward protrusions shown in FIGS. 54 and 55, but oriented vertically, as show in FIG. 62, or horizontally.

Split Block Assembly, which Lacks a Face Block Surface.

Often penetrations from the wall 301 are permanently attached to another structure, such as, without limitation, a line to an air conditioning compressor. These instances require a split block, which may be referred to as a split block assembly 201. The split block assembly 201 consists of two parts: a split block top 202 and a split block bottom 203, which may alternatively be referred to as a first piece and a second piece. The split block assembly 201 may be mounted horizontally or vertically.

Where the two halves meet is called an assembly seam 208. Located in the middle, the assembly seam 208 is a split protrusion hole 204. The split protrusion hole 204 is generally split evenly across the two blocks, however the split protrusion hole 204 may be located solely on either the split block top 202 or the split block bottom 203. Penetrations from the wall 301 will travel through the split protrusion hole 204.

The split block contains two features to ensure the split block assembly 201 remains in the correct orientation on the wall 301. First is a system to lock the two halves together. One of the split block top 202 or the split block bottom 203 will have a locking tooth 206 and the other side will have a corresponding locking receiver 207. Note that the locking tooth 206 and the locking receiver 207 may be reversed relative to the views shown in the figures.

The locking tooth 206 engages with the locking receiver 207 to create a non-permanent lock, allowing for easy installation. To permanently secure the split block assembly 201, a locking nail slot 205 may be included. This may correspond to the nail slot 115 on the split block top 202 and split block bottom 203. When a nail is inserted into the locking nail slot 205, the two pieces are permanently attached together, against the wall 301.

Note that the split block assembly 201 may, generally, only be mounted vertically. However, there is the possibility of other mounting orientations. In some configurations, one side of the split block top 202 and the split block bottom 203 may be joined via a living hinge, which may include a folding, or bendable, element. This side may have a nail hole or raised nail hole to lock the living hinge into place.

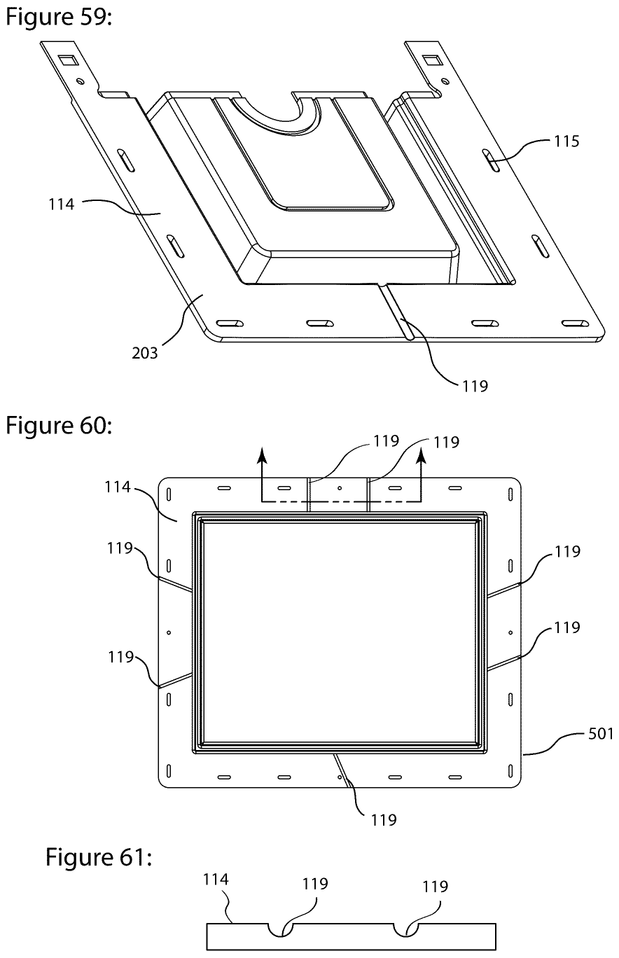

FIGS. 59-61 illustrate drainage holes or drainage channels 119. These features provide a mechanism for water that is between any of the blocks described herein to escape. The drainage channels 119 would, most likely, feed onto a water barrier or even siding elements to allow water to move outward, away from wall 301. Note that the drainage channels 119 may also be used on the hoodless backplate 102 or the hoodless block 501.

It is important to note that the split block assembly 201 has a recessed face 210. This is to allow a more convenient installation for re-models. To ensure the block can be easily painted the inner wall draft 209 was considered. The draft angle of this wall, and is considerably larger than most applications, in this instance, without limitation, it is a 15-degree draft angle. However, other draft angles may be used, including, without limitation, great than 8 or 12 degrees. Other walls have 1.5-3 degrees of draft. The increased draft on this wall generally allows for both an easier painting surface and faster water runoff. This increased inner wall draft 209 draft angle may also be included on the single-piece, hoodless block 501.

Note that none of the configurations herein include snap rings, which are normally required on vinyl siding mounting blocks.

The Detailed Description and the appended Figures are supportive and descriptive of the disclosure. While some of the best modes and other embodiments for carrying out the disclosure have been described in detail, various alternative designs, configurations, and embodiments exist for practicing the appended claims, as will be recognized by those having ordinary skill in the art.

What is claimed:

1. A solid siding mounting block, comprising:
a backplate formed as a two-piece member having a first piece and a second piece, wherein the backplate includes:
a nail flange; and
a perimeter wall extending substantially perpendicular to the nail flange.

2. The solid siding mounting block of claim 1, wherein the backplate further includes one or more attachment bosses.

3. The solid siding mounting block of claim 2, wherein the one or more attachment bosses include an annular attachment boss integrally formed with the first and second pieces of the backplate.

4. The solid siding mounting block of claim 3, further comprising a face block mounted to the annular attachment boss such that the perimeter wall circumscribes the face block.

5. The solid siding mounting block of claim 1, wherein one of the first piece and the second piece has a tooth, and wherein the other of the first piece and the second piece has a receiver configured to receive the tooth.

6. The solid siding mounting block of claim 5, wherein the tooth is integrally formed with the first piece as a first one-piece structure, and the receiver is integrally formed with the second piece as a second one-piece structure.

7. The solid siding mounting block of claim 6, wherein the tooth slides against and snap-locks into the receiver to thereby securely lock the first piece to the second piece and form the backplate.

8. The solid siding mounting block of claim 7, wherein the nail flange includes a first nail flange segment integrally formed with the first piece and a second nail flange segment integrally formed with the second piece, and wherein the tooth projects outwards in a first direction from the first nail flange segment and the receiver projects outwards in a second direction from the second nail flange segment.

9. The solid siding mounting block of claim 1, wherein the backplate is hoodless.

10. The solid siding mounting block of claim 1, further comprising an electrical box mounted to the perimeter wall and configured to store therein electrical wires.

11. The solid siding mounting block of claim 10, further comprising:
an electrical box cover; and
a recessed water diverter, wherein the recessed water diverter is between the perimeter wall and the electrical box cover.

12. The solid siding mounting block of claim 1, wherein the nail flange has a polygonal annular shape that surrounds the perimeter wall.

13. The solid siding mounting block of claim 1, wherein the backplate further includes a first mounting surface segment integral with the first piece and a second mounting surface segment integral with the second piece, the first and second mounting surface segments collectively defining a split protrusion hole.

14. The solid siding mounting block of claim 1, further comprising a perimeter raised section between the nail flange and the perimeter wall, wherein the perimeter raised section is configured to receive caulking.

15. A mounting block, comprising:
a first backplate piece formed as a first one-piece structure and including a first nail flange and a first perimeter wall segment projecting substantially perpendicular from a first inner perimeter of the first nail flange;
a second backplate piece formed as a second one-piece structure and including a second nail flange and a second perimeter wall segment projecting substantially perpendicular from a second inner perimeter of the second nail flange;
a pair of locking teeth integral with and projecting outward in a first direction from the first nail flange; and
a pair of locking receivers integral with and projecting in a second direction, distinct from the first direction, from a terminal edge of the second nail flange, the locking receivers each slidably receiving therein and snap-locking to a respective one of the locking teeth and thereby securing the first backplate piece to the second backplate piece.

16. A method of manufacturing a solid siding mounting block, the method comprising:
forming a backplate as a two-piece member defined by a first piece and a second piece, wherein the backplate includes a nail flange and a perimeter wall extending substantially perpendicular to the nail flange; and
attaching the first piece to the second piece.

17. The method of claim 16, wherein the backplate is formed with an annular attachment boss integrally formed with the first and second pieces of the backplate.

18. The method of claim 17, further comprising mounting a face block to the annular attachment boss such that the perimeter wall circumscribes the face block.

19. The method of claim 16, further comprising:
integrally forming a locking tooth with the first piece as a first one-piece structure; and
integrally forming a locking receiver with the second piece as a second one-piece structure,
wherein attaching the first piece to the second piece includes sliding the locking tooth against and into the locking receiver to thereby securely lock the first piece to the second piece.

20. The method of claim 16, wherein the backplate further includes a first mounting surface segment integral with the first piece and a second mounting surface segment integral with the second piece, the first and second mounting surface segments collectively defining a split protrusion hole.
